(19) United States
(12) Patent Application Publication
(10) Pub. No.: US 2016/0126521 A1
(43) Pub. Date: May 5, 2016

(54) RECHARGEABLE BATTERY CELL

(71) Applicants: Heikki SUONSIVU, Espoo (FI); Jukka Olavi JÄRVINEN, Hikiä (FI)

(72) Inventors: Heikki Pekka Suonsivu, Espoo (FI); Jukka Olavi Järvinen, Hikiä, OT (FI)

(21) Appl. No.: 14/897,246

(22) PCT Filed: Jun. 12, 2014
(86) PCT No.: PCT/FI2014/000010

§ 371 Date: Dec. 10, 2015

Related U.S. Application Data
(60) Provisional application No. 61/834,342, filed on Jun. 12, 2013.

(51) Int. Cl. H01M 2/16; H01M 2/14; H01M 10/46; H01M 10/0525; H01M 10/0585

(52) U.S. Cl. CPC H01M 2/1686; H01M 2/1673; H01M 10/0525; H01M 10/0585; H01M 10/465; H01M 2/145

(57) ABSTRACT

A rechargeable battery cell comprises a separator (10) as a load bearing vessel for supporting positive (13+) and negative (13−) electrodes that are attached by embedding and/or by coating or laminating at opposite ends of the separator (10). A carbon structure (12) can be embedded or coated on the separator (10). The carbon structure (12) can be a nano-structure or a carbon nanofiber structure for mechanically strenghtening and stabilizing the separator (10) surface.

The invention relates to rechargeable lithium ion cell and manufacturing method.

### BACKGROUND

The rally for distributed sustainable energy has created a great demand for highly efficient energy storage devices. Traditionally in medium size scale they have been deployed with battery technology. Unfortunately previous battery generations have been plagued by weak efficiency, high costs and poor durability when large battery assemblies are made.

Lithium batteries have been commercially available since 1992. It is very versatile energy storage device and it can be assembled with millions of combinations. Differences are huge so it could be argued if it is even reasonable to categorize all these cells under one label.

Until recently we have not been able to master the dynamics. Intentional production of nano-materials have enabled completely new set of tools to try out new things. Even so it could be said we're still taking baby steps to understand the technology and how to apply it.

Traditional method is to coat a thin pure metal foil with electrode paste. Next the electrode foils are mechanically manipulated to provide right thickness and size. Foils are either rolled over each other with separator or stacked.

The electrode pairs are only mechanically pressed against each other with a separator between them. External mechanical compression is required. It also requires capabilities from the separator. For example polypropylene separator can take a lot of mechanical stress but due it's structure it cannot be made too thick. From safety point of view thick separator would be best.

Current battery manufacturing relies on multi-step production phase. Many phases require a lot of handling. Also moving material between phases is a task. It restricts the size of the material patches in the process steps. Heavy and bulky objects are prone to mishandling. Or at least it requires heavy equipment and operators which adds cost.

Also building the production in patches creates variations between the batches and causes quality issues.

Lithium ion battery can be assembled in many various ways still keeping the structure the same. It is clear the handling of a 50.000 m long and 10 meter wide foil as one piece in present battery manufacturing facity would be tricky. Even impossible. On the other hand such amounts of paper is pushed through paper machines every day. With very high speeds up to 120 km/h. It would clearly be beneficial to have a robust continuous roll to roll manufacturing without need to manufacture many separate types of battery components including two metal foils with electrodes.

In the race to improve electrode paste conductivity many doping and mixing methods have been developed. Electrical conductivity have improved enough to question if traditional current collectors are even required anymore.

### SUMMARY OF INVENTION

The invention improves the large scale manufacturing by introducing a smooth roll to roll manufacturing. This allows very short storing times for electrodes and they have less time to get deteriorated before final installation to a battery. A continuous process also is less prone to quality variations. Minimizing waiting times between manufacturing steps is beneficial for quality and for production cost, as the cell intermediate products often require special inert storing environment to avoid corrosion.

One object of an advantageous embodiment is allow a simple manufacturing process of a very large high voltage cell. Further the battery of multiple cells in series according to the invention will be reliable, compact and robust. Also the balancing of cells and balancing the properties of electrodes over the cell electrodes areas is achieved in simple manner. The invention allows adjusting equalizing of the properties within the surface area of the cell electrode material, when several sells are connected in series. This can be done by adjusting the lateral conductivity lower than in prior art and arranging the current flow straight angle from the electrode, forcing the current per area about same in each stacked cell. This makes the ions to move and cover each cell electrode with about as thick layer.

By precoating paper separator with conductive additive say Carbon nano-components the electrode paste can be interlaced with it with high contact surface area.

One aim of the invention is to provide a Li-Ion battery cell with separator which is structural component providing the mechanical dimensions and integrity of the cell, providing same time a fluent path for electrons to travel and binding electrodes together without external pressure.

### DETAILED DESCRIPTION OF THE INVENTION

The invention is described with reference to enclosed figures.

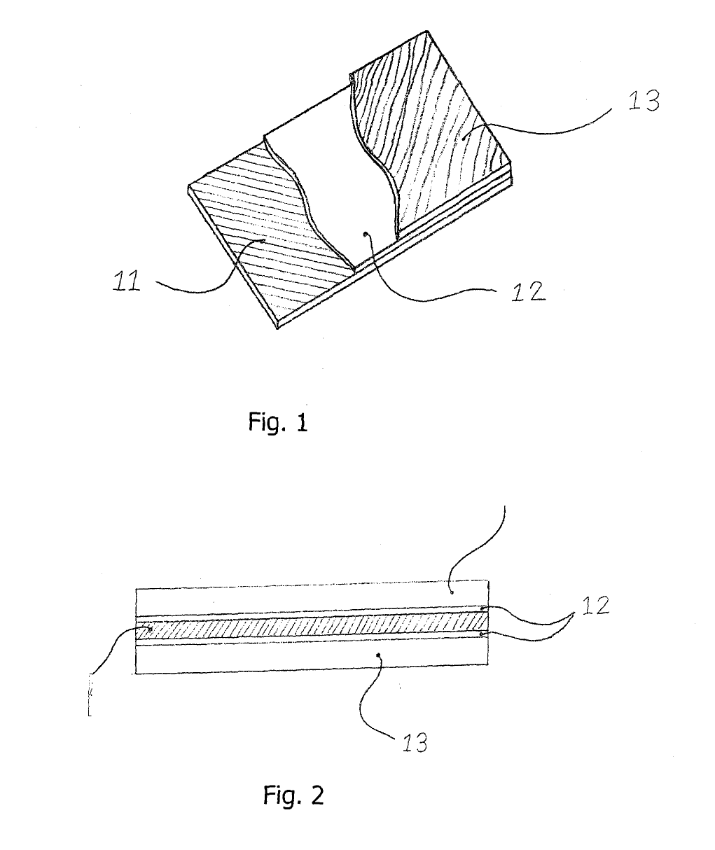

FIG. 1 depicts a layers on one side of the separator according to the invention.

FIG. 2 depicts section view of a separator and electrodes according to the invention

FIG. 4 depicts perspective view of a separator and electrodes according to the invention.

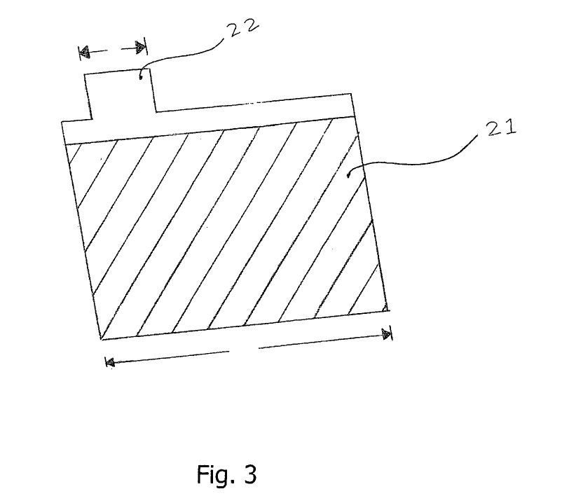

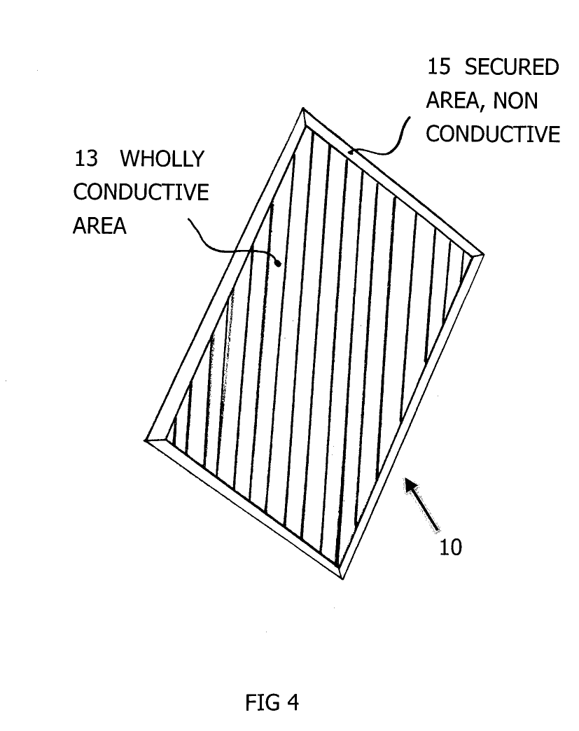

FIG. 3 depicts a prior art current collector of a electrode

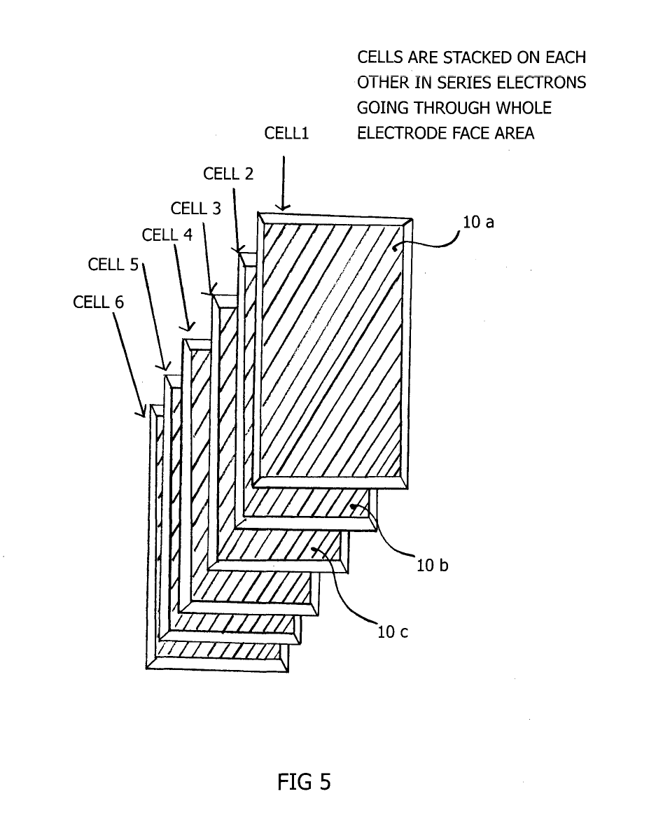

FIG. 5 depicts expoded perspective view of series connected multiple cells components of FIG. 4.

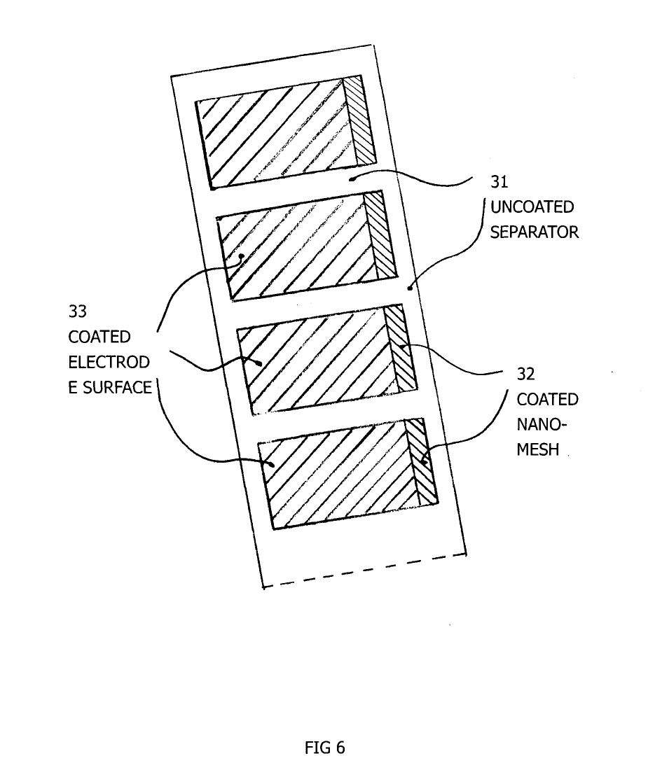

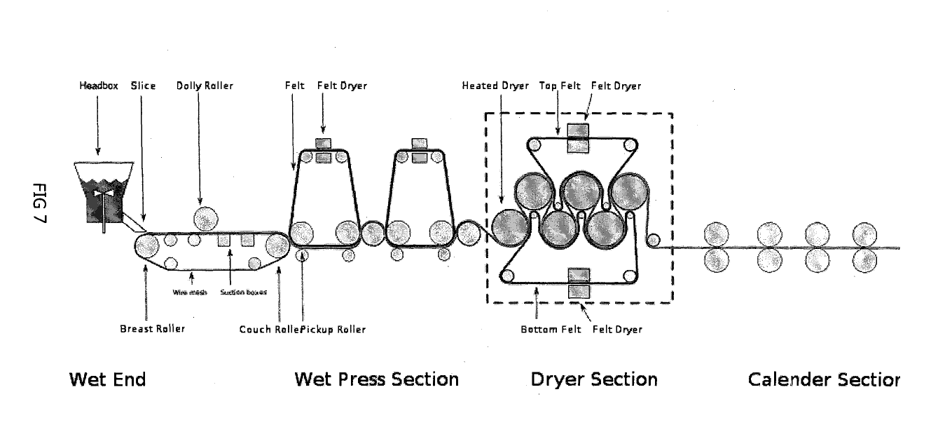

FIG. 6 depicts a intermediate product during manufacturing step of an embodiment of the invention.

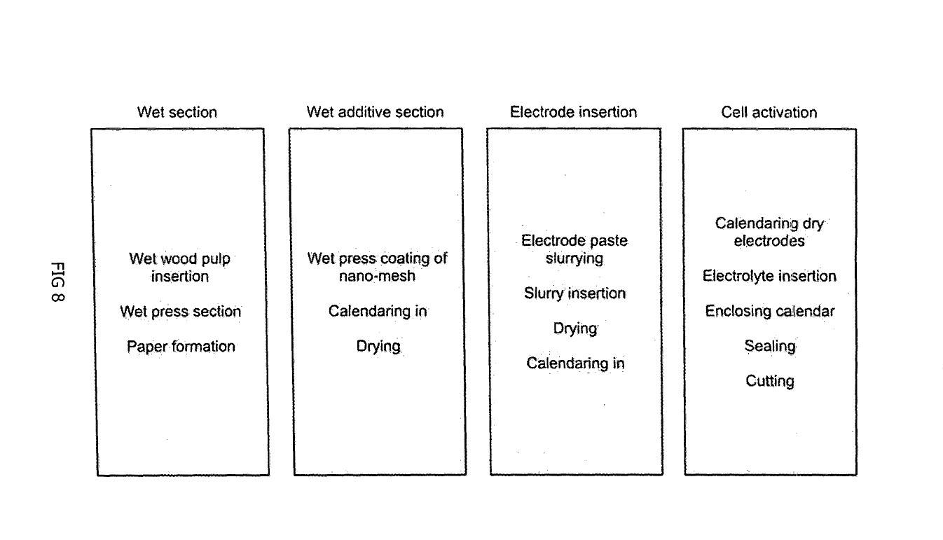

FIG. 7 depicts a schematic of paper mill.

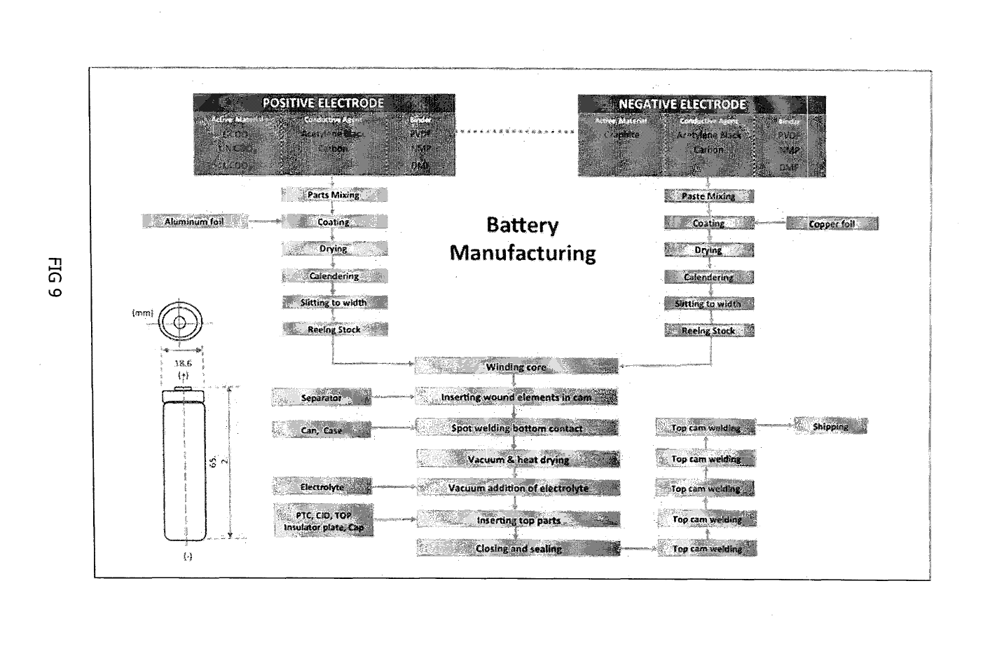

FIG. 8 depicts phases of manufacturing according to an embodiment of the invention.

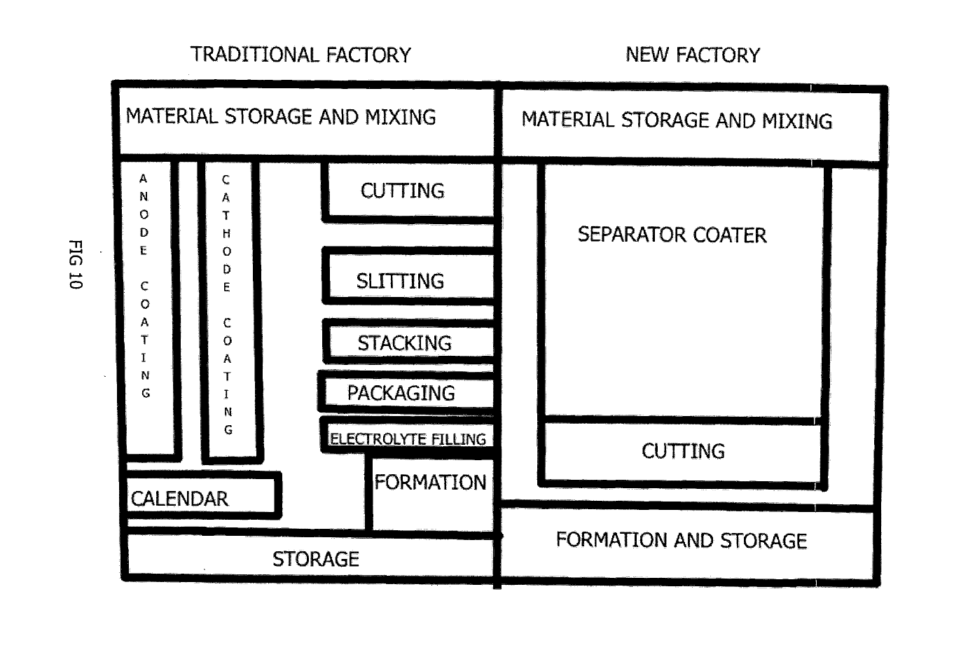

FIG. 9 depicts prior art battery manufacturing steps.

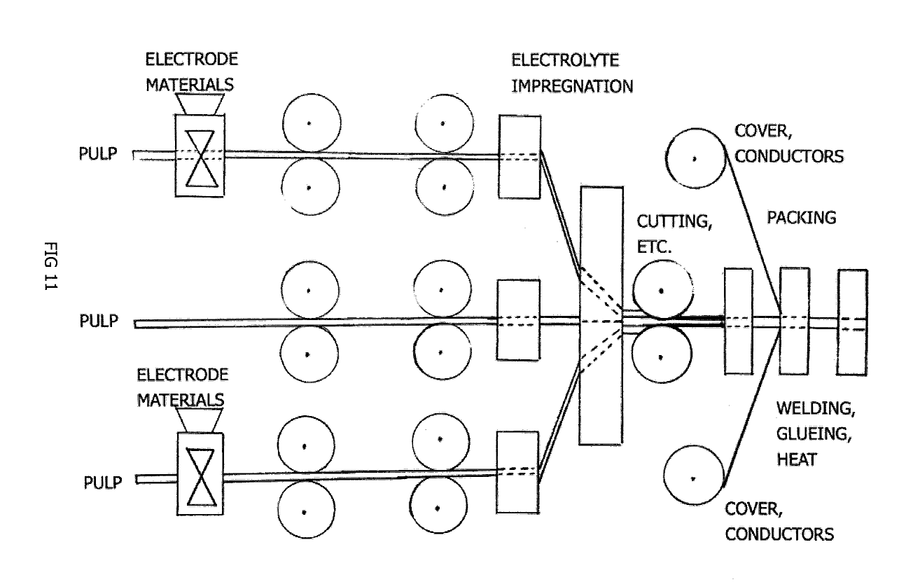

FIG. 10 depicts exemplary floor plans of present battery factory and a factory employing a method according to the invention.

FIG. 11 depicts schematic of embodiment using paper making technology for exemplary manufacturing method embodiment according to the invention.

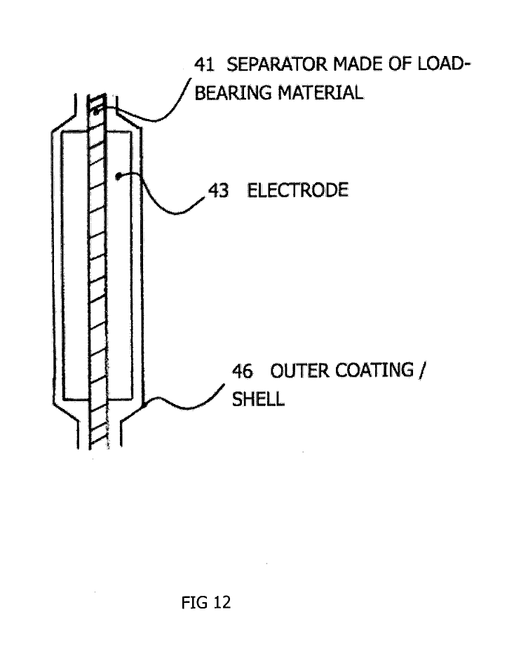

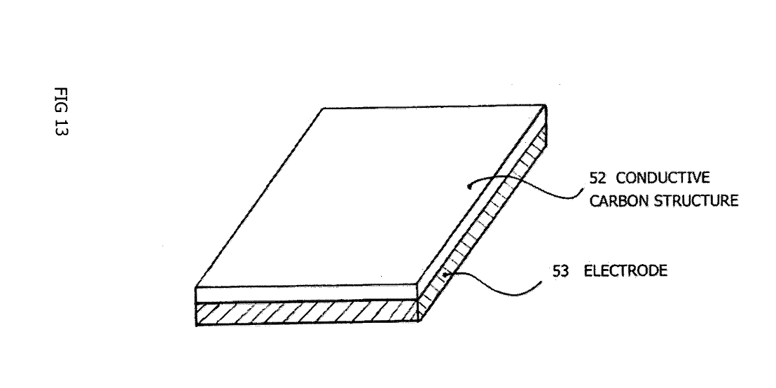

FIG. 12 depicts a closed cell according to the invention

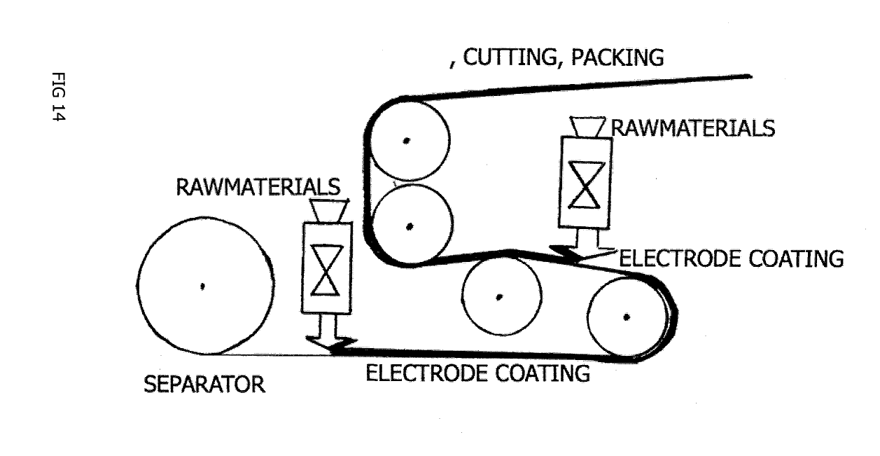

FIG. 13 depicts part of electrode in cut perspective view.

FIG. 14 presents another example of manufacturing principle according to the invention using reel to reel coating to prefabricated separator material.

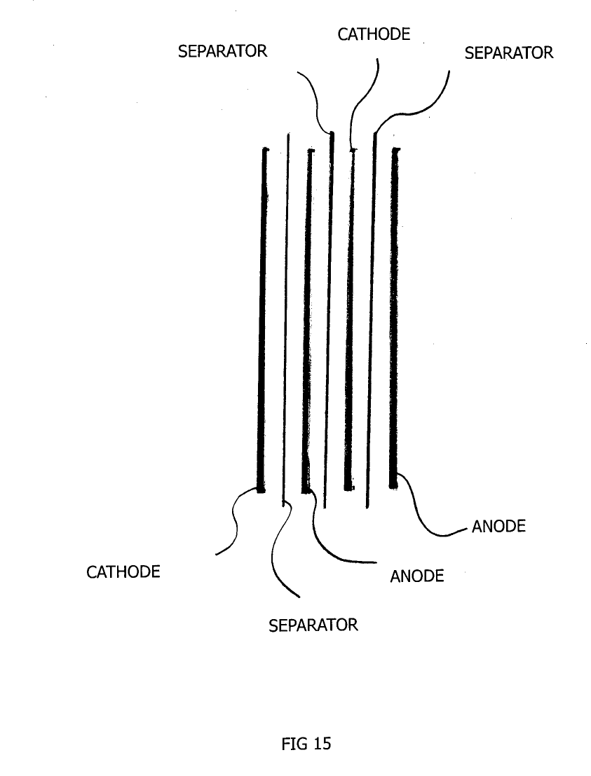

FIG. 15 presents a multilayer structure of a series connected battery of cells according to the invention.

Manufacturing process of a rechargeable Li-Ion cell uses the separator as a coatable vessel and where, at opposite sides, positive and negative electrodes are attached by embedding and/or by coating or laminating.

The separator may be made by normal paper-making process, during which the functional parts of the electrodes may be embedded to the paper. The separator material may be suitable pulp used for paper making. One requirement of the separator material is that it is not deteriorated by the electrolyte or by electrode manufacturing.

Many of the organic electrolytes used in lithium cells are compatible with cellulose. Fibers made of solvable cellulose (e.g. rayon, viscose, modal, lyocell cellulose acetate etc.) are pure cellulose without hemicellulose and therefore they are also usable. Also polymer and non-organic materials may be used. For example glass fiber, or polymer fibers may be used alone to create a paper-like felt or they may be added to the pulp or to the coating layer.

When part of the paper has absorbed the electrode, the actual distance between electrodes is as thin what we have today with plastic separators. The paper provides excellent binding between anode and cathode. Rendering external mechanical pressure obsolete. Also a carbon nanostructure is preferably combined to the separator structure during manufacturing process to increase current carrying capability of the electrode coating or electrode layer.

The carbon nanostructure may be formed during manufacturing the paper or other separator material or coating may be added to prefabricated paper or other corresponding material, like non-woven cellulose based fabric made of dissolving grade cellulose fibrous or suitably porous ion penetrating material. Known examples of these materials are used as sausage skin, medical tapes, dialysis diaphragm, non-woven wall paper etc. Also non-organic fibres can be used alone or with cellulose or other organic material. Suitable non-organic materials are glass fibre. Also non-fibrous materials can be used, like silica-gel or even super-absorbing gels may be added or embedded to fibrous material.

One important advantage over metal foils is that the fibrous or porous separator web can be dried with methods that are used in paper-making. Paper or other alike separator material dries through the load bearing separator material web itself to both sides of the web. This allows drying by heating from the paste side and the steam evaporates from the opposite side. That is impossible with metal foil, and the drying happens only to one side. Also the bonding to paper or porous material may be much stronger than bonding of the uncured paste to a metal foil. The invention allows fast heating and cooling without risk of detaching the electrode paste or carbon web from the foil. Also microwave heating may be used with non-metal separator material. This allows faster heating with high power without overheating the already dry web too much.

Porous separator may be coated with carbon also by mixing for example carbon to air or other gas and blowing the pulverized particles or fibers into the paper porous surface. Also other fibers or particles may be used, for example cellulose or cellulose acetate fibers may be added also in dry form with electrode material or before adding the electrode material. The coating layer may be textured or patterned by using a mask net or stencil in front of the gas flow. If masking of the gas flow is made backside of the separator web, the resulting pattern will not be sharp edged, but still for example the carbon web on the paper would copy also the mask pattern from backside also. Patterned carbon structures may be used for controlling the conductivity in the electrode plane directions. Also electrostatic or magnetic deposition can be used. Very high electric field strength may be used to create corona discharge to the web. Corona discharge is known to improve surface adhesion of some materials like polymers. That may allow for example adhesion between polyethene or polypropylene fibers and carbon or electrode material particles or paste material.

The dustlike powder form deposited coating or fibrous coating may be cured to base material by heat, chemical adhesion, or by radiation like ultraviolet curing. If web material includes for example PP- or PE-polymer, a corona treatment may improve adhesion.

One possibility with electrostatic deposition is electrospinning of fiber material on site. Electrospinning can be used to make very thin fibers. Typically electrospinning is made from solution, for example cellulose acetate can be spun from acetone solution.

Electrospinning may be combined with powder painting or electrospraying in order to spray the electrode particles with electrostatic powder painting method together with liquid form fibers. The electrospinned fibers may mix on the way to the particles if they are sprayed close to each other. The final curing may be made by calendering or by heating without pressure, or by for example radiation.

Many of the coating methods used in paper-making are pliable for adding conductive mesh and electrodes on the separator in roll to roll manufacturing or when the separator is manufactured from pulp.

The invention is not limited to wet processes, but the electrode material may be added also using dry processes. One example is the methods used for manufacturing wound pad material from rayon or other fibres by blowing the fibers with air or gas to the felt or on the porous gas penetrating web, and calendering or cluing the resulting material may be done with additives or simply by heating.

Manufacturing process of a rechargeable Li-Ion cell according to the invention uses the separator as a coatable vessel and where, at opposite sides, positive and negative electrodes are attached by embedding and/or by coating or laminating.

The separator may be made by normal paper-making process, during which the functional parts of the electrodes may be embedded to the paper. The separator material may be suitable pulp used for paper making. One requirement of the separator material is that it is not deteriorated by the electrolyte or by electrode manufacturing.

Combining carbon nanostructure with separator makes electrode-separator interface mechanically more stable, stronger and durable

Using carbon material bound with separator as base for electrode paste in manufacturing of durable attachment of the electrode.

FIG. 1 presents coated cell separator 10. Figure is partly cutout, presenting cell separator 11, that is coated with carbon based nano-mesh 12, and electrode paste 13. The carbon layer may be carbon nanofibers, or carbon black. The layer thickness may be under a micrometer or some hundred micrometers, if combined with separator base material.

FIG. 2 presents sectional of cell structure according to the invention. Separator 11 may be paper, and both sides of it there is carbon mesh layer 12 coated or embedded to the separator 11. Teh carbon mesh helps to bound the positive electroce 13+ and negavive electrode 13− to the separator.

FIG. 3 presents prior art cell current collection seen from top of the electrode foil. Coated electrode 21 is made in top of a metal foil. The tab 22 collects the current from the foil. The foil may be for example 250 mm wide, 6 mils thick, resulting 38 square millimeters cross area. The tab may be for example 40 mm wide, made of the same foil, resulting 6 square mm cross section. Previous generation of technology where electrode foils were coated vast amount of the used copper and aluminum foils were just ballast. The currents passing through the tab-area was the bottleneck in the design. Not the coated current collector-electrode interface (CCEI). For example certain prismatic cell had 100 sqmm at the tab area and in the cross section at CCEI part of the electrode was 625 sqmm.

This part would not require more than 10 sqmm for optimal operation.

Pure metal foils are not cheap which adds the cost of cells for no good reason. Metal foils can also provide heat conduit and sink to cool down the electrodes under stress but in this case they are merely negating aspects generated by the design itself.

Traditional cells are mechanically combined from three separate processes (anode coating, cathode coating and reeling out the separator). These separate processes have to be synchronized and controlled in precise manner.

Each MassiveCell electrode according to the invention can provide vast surface to connect to each cell when stacked. Thus enabling low electrical currents per square millimeter. This also minimizes the heat losses. To compare the previous example of the prismatic cell the new design can provide ‘tab-area’ of 6.000.000 sqmm with greatly reduced costs.

FIG. 4 presents a coated cell 10 where most of the area is coated or enclosed with conductive material 13. The fringes 15 are preferably non-conductive for creation of secured area.

FIG. 5 presents a exploded view of a cell stack according to one advantageous embodiment of the invention. A cell stack can be formed by stackig FIG. 4 cells on top of each other. The cells 10.1 to 10.6 are electrically coupled from their positive and negative electrodes through conductive enclosure material, where the enclosure material can be plastic or other similar material which has been manipulated to add electrical conductivity.

Such contact areas are at uncomparable level to previous designs. Creating serial connections by these means the high voltage battery pack will be extremely economical to construct (picture 5).

Also the power capabilities of such stack is uncomparable to previous generations. Even very high (+100 C) discharge rates can be achieved.

Creating cell stacks as described it is also possible to affect to the conductivity of the current conduits between cells. Various methods exist. The structure may have electrically controllable layer which can be closed instantly if needed. The enclosure material may have thin or printed electrical circuitry. **A battery casing may directly couple cells to each other with material to open electrical circuit at certain thermal or other set threshold.

Multilayer separator structure may include includes electrical components to supervise or control the cell where they are installed in.

The cell may comprise a multilayer enclosure structure which includes electrical components to supervise or control the cell where they are installed in.

Cells may be stacked in a way that enables full or partial direct coupling of cells directly from their electrodes in serial connection

Every cell can be insulated to their own electrolyte compartment.

Electrolytes which do not allow high voltages would be contained to their own compartment for maximal lifetime. While it is possible to build custom electrolytes to allow even chemical balancing methods between cells we still need to understand better the technology before implementing such to commercial products.

Paper separator can be made on-site from pulp. A fresh and wet uncompressed structure can be coated before introducing nano-mesh. Creating very strong binding between paper and electrode (FIG. 2).

The invention allows to achieve a continuous battery electrode pair manufacturing method, which provides fully functional cells without requirement to interrupt the process, where 1) continuous separator is made out of raw materials on site 2) electrode paste is mixed in continuous process and applied to both sides of the separator 3) the separator is coated wholly or with intervals 4) the created solid electrode pair around the separator is enclosed with tight and non conductive or conductive material from the part which is in connection to electrodes 5) sealed cell structure is applied with electrolyte 6) finished cell is stacked for formation charge 7) finished cell is stacked directly to the application product at the factory for the wait-period

The above is very common way to manipulate the external properties of paper.

FIG. 6 presents a way to make a cell that is more compatible with present technology. Certain areas 32 can be precoated with carbon layer in a way the electrode coating 33 will not be reached to such areas but still the electric conductivity is provided to this ‘tab-areas’ 32. Thus allowing the traditional mechanics of a Lithium ion cell.

A coating method which allows multidimensional coating of a separator by varying the layer thicknesses according the specific dimensional requirement, providing specific capacity per sqmm as a variable value. This allows also tab-areas with higher conductivity.

Coated area can be made very complex. The dimensions and shapes can be very distributed. Creating for example a ring-shaped cell is possible where the center of the cell is hollow.

A cell structure may comprise a coated separator which has been coated only partially providing closed and sealed loops around uncoated areas where, uncoated areas are cut as holes.

Controlling the material losses is important. The accuracy of MassiveCell method is uncomparable and these losses are significantly lower due the very fast and large production volumes.

Since the paper manufacturing may be the base process, the scale of volume is extraordinary compared to traditional methods. Continuous sheet from pulp to ready battery is possible to achieve. Battery factory can therefore produce many times more products compared to traditional factory. FIG. 10 presents exaples of a factory according to the invention and prior art factory with same foot print.

As FIG. 6 presents the separator may be coated only partially to create small battery cells.

Coating can be intervalled so the product can be produced by latching and stacking without cutting the separator. Since other side is anode and other cathode the folded stack creates even pairs with anodes facing anodes and cathodes facing cathodes. No additional separation is required to build a high energy single cell. Such design would rely on quite low power utilization due the thin design of sandwiched electrode in the middle. A current collector may be added between two alike sandwiched facing electrodes for higher power utilization. Anode and cathode current collectors may extend out from opposite sides of the parallel connected single cell parts. Even if metal foils are used, the resulting structure may be better than present cells. The current collector is not needed for mechanical strenght and the manufacturing of the cell material is faster. The foils may extend to some distance from the folded separators and the current collector may be folded from single long foil or mesh for both electrodes. The electrode plating may be even continuous over the folds, if the separator can stand the folding. The current collectors may be longer than the electrodes and still made of single uncut folded piece. The sides with no folds should have a non-conductive area as referred 15 in FIGS. 4 and 5. Because the current collector needs not to be separating the two alike electrodes, the current collector may be made of a mesh, for example a metal foil may be cut with short cuts and then the cuts can be stretched to diamond shaped holes of a mesh. This

A highly efficient stacking method of built cells can be achieved, when all cells are built on continuous separator and printed to mirrored or unmirrored dimensions for matching when stacked.

If the anodes and cathodes are made mirrored dimensions in turns on the same side of the separator, the folded and stacked structure will form a series connected cells without cutting the separator to sheets.

Such design could be utilized in solar cells with extremely thin design and moderate flexibility.

The coating process can be only one sided on the separator. This finalizes the prismatic assembly with even pairs around the separator in certain cases.

The distances between coated areas can be unique to allow ‘stack'n'go’ ready cells in mere seconds. The stacks can be inserted to traditional prismatic or pouch packages per customers request.

If cells are created with only one pair and one separation between them the continuous production allows closing the pair between say plastic wrap without cutting the separator.

This allows a continuous battery electrode pair manufacturing method, which provides fully functional cells without requirement to interrupt the process, where 1) continuous separator is made out of raw materials on site 2) electrode paste is mixed in continuous process and applied to both sides of the separator 3) the separator is coated wholly or with intervals 4) the created solid electrode pair around the separator is enclosed with tight and non conductive or conductive material from the part which is in connection to electrodes 5) sealed cell structure is applied with electrolyte 6) finished cell is stacked for formation charge 7) finished cell is stacked directly to the application product at the factory for the wait-period.

A battery pack can be built to very high voltages with very high speed and low cost. This could enable electric vehicle revolution due fractions of battery costs seen today. Also the mechanical advancements allows more energy dense and powerful batteries to all electric mobility applications.

Due the thin composition it is also possible to insert electronic circuits to the structures. Thermal measurement probes, voltage measurement and any other property which is seen fruitful to be measured. Multilayer enclosure structure may include electrical components to supervise or control the cell where they are installed in

With further development in measurement technology it is possible to instantly and factually determine the state of charge of each cell. For example the mechanical thickness of electrodes and their (anode/cathode) respective relation of thickness can be indicative to the state of charge. Instant state of charge indicator which operates by mechanically measuring the thickness of electrode material

The battery management modules can also provide communication and balancing energy paths through individual or serially connected cells. Thus making any external cabling unnecessary. Ready made battery systems with integrated battery management can be achieved by just stacking the cells with electronics for battery management for each cell.

The electrode and current collecting carbon web of the cells intended for series connection by stacking is advantageously made with limited electrical conductivity on the plane directions of the electrodes. That way the charging current through the stack and through each cell is forced to go moderately straight between the bottom and top electrodes and current collectors. Then the current in each area of each cell will be nearly same, and if one cell has weaker conductivity, still the current is about the same and because of that the amount of ions is also about the same. That will force the ions to move sideways by bit higher electric voltage. The conventional solution with metal foils will keep each part of electrodes in same potential, and less conducting parts of the electrodes will have less current and less ions will be active to those parts. The amount of active electrode material will not balance in that case.

Due the low cost and slim design various redundant circuits can be installed to ensure robust operation of the cell and systems. Cell separator, electrode, current collector or enclosure may be integrated with multiple battery management modules for redundancy.

Due the design cell is nearly immune to pressure changes and orientation of the installation. Space and deep mining applications are therefore enabled with high energy cells that have extraordinary cycle and calendar life.

When the cell becomes to it's end of life the recycling process is extremely simple. Most of the materials are released in carbon based pulp when the structure is superheated in non-oxygen environment. When done right thermal runaway will not occur.

The cells according the invention may be recycled my a recycling method which disassembles cell components as they are and such materials are used to remake cells without processing the materials.

** Anode and cathode can be electronically separated, cleaned and refurbished to be used as-is to next battery. Current advancements in technology and studies provides us nearly 99% recyclable Lithium battery which is safe to use.

Raw materials can have over 100-year lifetime in the circulation creating enormous business just in energy storing and peak shaving for renewable energy generation. As a business model it is arguable if selling batteries is even reasonable anymore. Energy could be sold as a storage service in any application.

In electric vehicles the integrated system can report and charge consumed energy. Battery system would be released to the customers use by granting a fee when returning the pack which have come to EOL. So in fact battery manufacturer pawns the pack to customer.

The battery according to the invention and recycling scheme allows a method to bill the battery usage with remotely measured energy consumption from the cell.

The battery management may support an automated software process to generate electronic invoices from used energy from the application, where the application is a portable or transportable device and the consumption information is submitted over wireless or wired communication medium.

The battery pack designed around the flat cell can open various new ways to make safer battery packs. For example the conductive sheet between cells can have conductive spots to transfer the electrons between cells. The conductive spots are mechanically attached to the hull of the battery pack while the cells are allowed to move. The friction between sheets is calculated and applied in a way that only very high accelerations in collision situation moves the cell stack to the direction of the collision. This offsets the conductive dots in the matrix rendering the cell stack externally to zero volts.

In comparison the situation mimics the situation with every cell having it's own shock fuse or contactor. This mechanism is resettable only by opening and disassembling the battery pack. This can be made by a mechanical assembly where battery cells are stacked on each other with a layer of conductive sheet, where the sheet is only partially conductive and is allowed to move from the alignment, to disconnect the electrical conduits, if certain set amount of inertial forces are applied to the cells or to the arrangement enclosure.

The friction holds the cells static in respect of the battery pack enclosure. We recognize there are other failure modes such as crushing which have low G-forces. To ensure safety in such situations there can be crush zone in the battery pack. This zone allows the external part of the pack to deform without releasing the internal pressure inside.

Stacked cells may also have air channels or channels for any suitable fluid around them but also between the conductive sheets between them. If the air pressure changes at any side of the enclosure the air will flow to even out the pressure differences. Air will flow through the channels lessening the friction which holds the cells in their respective places. Lower friction allows the g-force switching with lower forces. It can be also built in a way that the air pressure it self transports cells to offset the conductive spots. Mechanical assembly may be made, where battery cells are stacked one each other with a layer of conductive sheet, where between the cells and sheets have mechanically manufactured fluid or air conduits to lessen the friction between stacked layers if fluid or air pressure changes between compartments around the stack assembly. The fluid may be selected also so that it is inert and it has a boiling point in a suitable pressure and temperature so that the expanding fluid vapor may lessen the friction between the cells or even separate the cells.

These means are combined with others to ensure lower voltages available externally from the pack in the event of accident. Also the instantaneous action of such devices reduces hugely the risk of fire.

In one possible embodiment of the invention, the separator can form a load-bearing or structural component, to which other components of laminated, glued or otherwise attached.

A Li-Ion battery cell may be made, which has separator which forms a load-bearing or structural component

Instead of gluing electrodes to separator, the electrodes can be absorbed or embedded in the separator material sides. This will make a stronger structure than glued construction, making the battery last longer.

Paper separator is more porous and thicker than plastic. To manufacture paper the mass is pressed until it becomes dense enough. From carbon (for example) it is possible to build long chain- or fiberlike nanostructures, which will be embedded in the surface of the paper overlapping, forming a strong interface or surface (picture 13). To this surface a electrode, for example, containing carbon or other electrode materials, is formed. This will form a carbon matrix with large surface area. Pressing (calendering) will press anode and cathode closer to each other. With correct process, paper surface becomes strong on both sides, but will be porous enough to allow electrolyte to work.

Paper is used in batteries, but not in charged li-ion battery types. This is mostly due to problems making it thin and strong enough. The need to make it strong is necessary due to high pressure and thermal expansion. Older electrode materials expanded when Lithium Ions absorbed to them.

When separator structure is based on paper, carbon nanostructures can be embedded or mixed glued into the paper, making the combined structure very strong. The long carbon chains or structures are mixed with paper fibers, binding them together, and making paper stronger, allowing application to rechargeable Li-Ion batteries. (FIG. 13)

Combining carbon nanostructure with separator by embedding it into separator structure to increase current carrying capability. Combining carbon nanostructure with separator to make electrode-separator interface stronger and durable.

FIG. 7 presents a known paper mill schematic. The manufacturing method according to the invention can be based on the same principle.

FIG. 8 presents the manufacturing steps of one embodiment of the manufacturing method according to the invent. Cells may be manufactured in a continuous process from pulp to ready cells.

FIG. 9 presents a prior art manufacturing steps. When the electrodes are made to to different metal foils and combined with the separator and the drying is then made in large part after the cell parts are canned, needing vacuum and heating for quite a long time, because the metal foils slow down the steam evaporation.

FIG. 10 shows the factory floor plan of a conventional factory and of a factory according to the invention. The invention lessens separate functions of the factory, as one separator is coated on both sides and also the drying is much faster without steam blocking metal foils.

FIG. 11 presents a manufacturing arrangement of one embodiment according to the invention. The separator and electrodes are all made from pulp, and combined in the process to one web. The layered structure manufacturing is already used for making some cardboard qualities.

FIG. 12 presents a ready sealed package of the cell. The load bearing separator 41 is is coated with electrodes 43. The structure is sturdy enough and it may be sealed only by flexible outer cell 46. Outer cell may be plastic wrap or even a coating. The gas and steam diffusion may be enhanced by using metallized plastic coating, if necessary.

FIG. 14 presents an embodiment in which the separator is ready made and taken from a roll in the beginning of the manufacturing. The electrolyte materials are coated to separator, pressed, dried and calendered.

FIG. 15 presents an exemplary principle of a layered battery of the cells according to the invention. In the stack cathode and anode are stacked to electric contact, and the electrode area is used to conduct the current through the whole stack. Between the anode and cathode there may be used carbon-based paste or coating, or for example a thin conductive polymer foil or coating. Conductive polymers or carbon mixed polymers may be used. The conductivity in the plane direction of the electrodes may be restricted by patterned conductive layer between the electrodes.

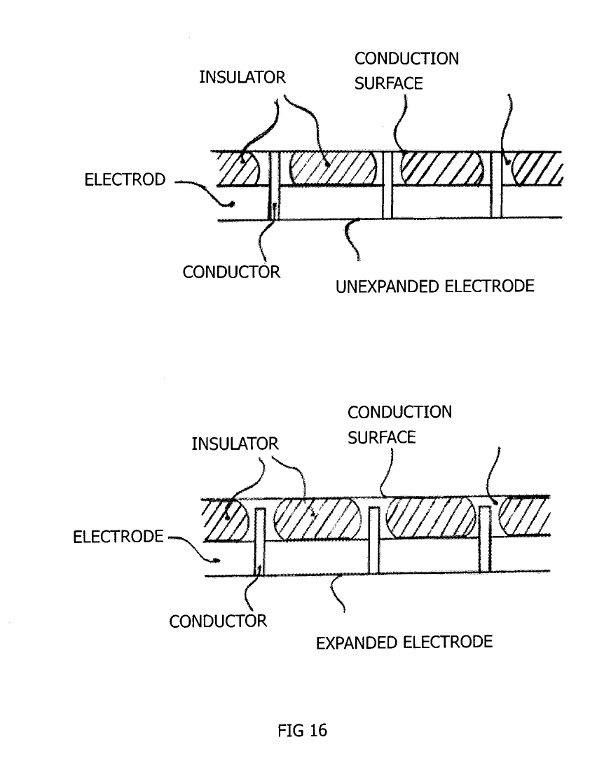

FIG. 16 presents examples of current controlling structures. The electrode thickness changes during charging. The increased thickness disconnects the conductive studs from charging current feeding rail. This allows stopping the charging when electrode thickens is in prescribed level. The same principle may be used for only indicating the threshold thickness to battery management. It is also possible to integrate other kind of measurement sensors to the structure. Instead of electric contact, an optical or capacitive sensing may be used to measure the sell thickness or other properties.

1. Rechargeable battery cell comprising a separator as a load bearing vessel for supporting positive and negative electrodes that are attached by embedding and/or by coating or laminating at opposite sides of the separator

2. A rechargeable battery cell according to the claim 1, comprising carbon structure embedded or coated on the separator before forming the electrodes.

3. A rechargeable battery cell according to the claim 2, wherein the carbon structure is carbon nano-structure or carbon nanofiber structure for mechanically strengthening and stabilizing and the electrode separator interface.

4. A rechargeable battery cell according to the claim 1, wherein the conductivity of carbon structure and electrode material is restricted in the electrode plane directions in order to force the current through stacked series of cells to go more straight between top and bottom cell current collectors.

5. A rechargeable cell according to the claim 4, wherein the conductivity of carbon structure and electrode material is restricted in the electrode plane directions by patterning the carbon structure, or by selection of shape and sizes of the electrode and carbon particles, or by making the conductive carbon structure thin.

6. A rechargeable cell according to the claim 1 comprising a multilayer enclosure or separator structure which includes electrical components to supervise or control the cell where they are installed in.

7. A battery of series connected rechargeable cells according to the claim 1, wherein the cells are stacked and the cells are connected essentially the whole electrode areas to next cell or to the top and bottom current collectors.

8. A battery according to claim 7, comprising means for opening electrical circuit between cells at certain thermal, electrode thickness related, or other set threshold.

9. A manufacturing method of battery cells, wherein the electrodes are formed on load bearing separator web in a continuous manner.

10. Use of cells according to one of the claims 1 to 7 combined with solar cells.
